(19) United States
(12) Patent Application Publication
(10) Pub. No.: US 2022/0000331 A1
(43) Pub. Date: Jan. 6, 2022

(54) Automated Cleaning of Cookware

(71) Applicant: Kitchen Robotics Ltd, Modiin (IL)

(72) Inventors: Yair GORDIN, Modiin (IL); Ofer ZINGER, Ramat Hasharon (IL)

(21) Appl. No.: 16/920,798

(22) Filed: Jul. 6, 2020

(51) Int. Cl. A47L 15/46; G06K 19/07; G06K 19/06; G06K 7/10; G06K 7/14; A47L 15/42; H04N 5/30

(52) U.S. Cl. CPC A47L 15/46; G06K 19/0723; G06K 19/06028; G06K 7/10366; G06K 7/1413; A47L 2501/01; H04N 5/30; A47L 2401/04; A47L 2501/30; A47L 2501/07; A47L 15/4295

(57) ABSTRACT

The automatic cookware cleaning apparatus, covered in the present invention, personalizes cookware cleaning and drying operations, reducing energy consumption and water wastage. Cleaning method, plan, duration and intensity, among other parameters, can be optimized considering variables such as the cookware geometry, materials, amount and type of dirt. Moreover, assigning an ID of the cookware combined with a computer vision, which determines the amount and type of residue on the cookware and identifies its properties, enables utilization of the cleaning and drying process parameters. Nevertheless, the cleaning and drying process is utilized when the apparatus is combined with an automated cooking system and dish cooking parameters, such as ingredients and heating regime, are analyzed.

### FIELD OF THE INVENTION

The present invention relates to an automatic dishwasher for washing and rinsing cookware or similar articles using optimal utilization of resources. Further, the said invention optimizes resources by sensing the variety and status of the cookware to be cleaned through machine vision technology and deploying resources accordingly.

### BACKGROUND OF THE INVENTION

Dishwashers are generally used for cleaning cookware without too much human interferences. Mechanical dishwasher cleans by spraying hot water, typically between 45 and 75° C., at the dishes, with lower temperatures used for delicate items. The user of dishwasher may sometimes select between different programs, but the dishwasher itself operates regardless of its actual content, the type of cookware, or the type of dirt to be cleaned. In such circumstances, optimal usage of water, energy as well as time gets a back-seat. Use of automation in dishwasher/cookware cleaning lends an edge over the mechanical one in automating the functional process of such dishwasher/ cookware. Such automated machines have so far been confined to optimized operation and automation of the cleaning components of the machine and in some on selective conservation of resources. Various prior arts exist in the said aspect.

U.S. Pat. No. 4,641,671A titled, “Automatic dishwasher” talks of an automatic dishwasher which comprises an enclosure for accommodating articles to be washed, a washing solution tank arranged below the enclosure, a hot water storage tank for containing a predetermined amount of hot water for rinsing use, a plurality of nozzles for spraying a liquid medium towards the articles in the enclosure, a motor-driven pump, a first piping connecting a discharge port of the pump with the nozzles, a second piping connecting both of the solution and storage tanks with a suction port of the pump, and a valve assembly disposed on the second piping and operable to close a first passage between the suction port and the storage tank and to open a second passage between the suction port and the solution tank during the washing operation in which the articles are washed, and to open and close the first and second passages, respectively, during the rinsing operation in which the articles are rinsed,

CN203280351U titled, “Automatic dishwasher” is that of a utility model of an automatic dishwasher which comprises a water tank, a dish distributing mechanism, a conveying mechanism, a dish washing mechanism, a dish turnover mechanism, a cleaning mechanism and a. drying mechanism. A contact probe mechanism is connected on the dish distributing mechanism, and the conveying mechanism is arranged below the dish distributing mechanism. The dish washing mechanism is arranged in front of the conveying mechanism, the dish turnover mechanism is arranged in front of the dish washing mechanism, the dish turnover mechanism feeds reversely-arranged dishes into the cleaning mechanism, and a sterilizing mechanism is arranged in front of the cleaning mechanism. The dish distributing mechanism is provided with the contact probe mechanism, and the dish washing mechanism is connected with an actuating device. The automatic dishwasher can eliminate dirt thoroughly and reduce water consumption.

U.S. Pat. No. 8,617,316B2, titled, “Energy management of dishwasher appliance” discusses a dishwasher that comprises one or more power consuming functions and a controller in signal communication with an associated utility. The controller can receive and process a signal from the associated utility indicative of current cost of supplied energy. The controller operates the dishwasher in one of a normal operating mode and an energy savings mode based on the received signal. The controller is configured to change the power consuming functions by adjusting one or more of an operation schedules, an operation delay, an operation adjustment, and a selective deactivation of at least one of the one or more power consuming functions to reduce power consumption of the dishwasher in the energy savings mode.

However, in none of these inventions, optimization of resources, e.g. time, detergent, energy, etc. is based on the dirt level of the washing item. Such optimization based on the state of the dishes /cookware to be washed is considered highly efficient on account of the total flexibility in optimizing all the resources simultaneously and thus scores above the technical gradation of the existing prior arts. The present invention is an effort in that direction and discusses a process of optimizing entire resources and hence the costs of these on the basis of the cleaning status of the dishes/cookware.

### SUMMARY OF THE INVENTION

An aspect of the present invention is to provide, an automated cleaning of cookware that is more efficient, in energy consumption, cleaning time and in water usage, than conventional dishwashers which disregard the type of cookware and the dirt level and composition which results in water wastage over cleaning and avoiding focusing on specific places (and instead work “statistically”).

Another aspect of the present invention is to provide for a personalized cleaning operation depending on the cookware to be cleaned thereby, enabling improved efficiency, avoiding over-cleaning “light” dirt, improving effectiveness of each cleaning operation, reducing required energy to perform the cleaning operation and the drying operation.

In another aspect of the present invention, the type of cookware such as a pot, a pan, or the like, or the material of the cookware, such as aluminum, clay or the like, may be determined. Further, taken into consideration by the apparatus of the present invention while cleaning is the geometric shape of the cookware, the diameter and depth of the pot may be determined. This is due to the fact that different materials are cleaned at different pressure levels using different cl caning methodologies.

In still another aspect of the present invention, the apparatus utilizes computer vision techniques to identify the type of cookware, the material of the cookware and the properties apart from the dirt present in them, using sensors, such as a light-sensitive camera, a range sensor, a radar, an ultra-sonic camera, for image acquisition of the cookware.

In an aspect of the present invention, a classifier is trained by employing a supervised learning technique, through the usage of labeled dataset comprising of the images obtained by sensors, and labels thereof provided by an automated cooking machine, to automatically determine the type of dish that was prepared based on the residual dirt appearing afterwards.

In an aspect of the invention, the apparatus performs analysis for creating a cleaning plan which may be performed, taking into account, the geometric shape of the cookware, the specific stains, and the relevant dish. The analysis creates a cleaning plan that identifies a starting point for the cleaning operation and the cleaning methodology, including the type of cleaning (e.g., steam-based, jet-stream, scrub, or the like). Cleaning of a surface of the cookware may be planned taking into account an optimal angle so as to direct the steam to hit the surface at the most suitable angle for optimal cleaning.

In another aspect of the present invention, analysis of cleaning performed by the apparatus, determines the cleaning properties like the cleaning angle, pressure, intensity, duration, speed, and other different properties at different locations in the cookware.

In still further aspect of the present invention, the property of cleaning angle determined by the apparatus, may be an angle at which a steam is directed at the cookware to remove dirt. It also considers optimal angles and sub-optimal angles and maximizes utilization of optimal angles.

In another aspect of the present invention, parameters of the cleaning may be determined, like water pressure, steam pressure, steam intensity and the cleaning time. The cleaning is also planned while taking into account the geometric limitations imposed by the shape of the cookware, such as its depth and diameter.

In a further aspect of the present invention, a drying plan is also determined which is executed for cleaning the cookware and drying thereof.

In still another aspect of the present invention, identification of cookware is achieved, by embedding a cookware with a marker providing the desired information, such as an RFID, barcode, or the like.

In still another aspect of the present invention, the system. of the apparatus comprises a database where each cookware's ID is mapped to its relevant parameters which are utilized for identifying the properties of the cookware so as to determine the cleaning and drying method for the particular method. In this aspect, the ID may be a product-specific ID, so that, different pots of the same kind, have different IDs and usage of each cookware can be tracked.

In another aspect of the present invention, the analysis of the apparatus may determine the type of residual dirt on the cookware. This may also involve, utilizing computer vision to identify residue on the cookware to identify which dish was prepared and which type of dirt remains on the cookware that is to be removed by the cleaning operation.

In another aspect of the invention, the apparatus can be utilized and is applicable for cleaning and drying of cookware, dishware and cutlery.

### BRIEF DESCRIPTION OF THE DRAWINGS

FIG. 1 is a Flowchart representing the process of the cleaning apparatus of the present invention.

### DETAILED DESCRIPTION OF THE PREFERRED EMBODIMENTS

One technical problem dealt with by the disclosed subject matter is to provide an automated cleaning of cookware that is more efficient, in energy consumption, cleaning time and in water usage, than conventional dishwashers. As dishwashers disregard the type of cookware and the actual dirt, they may waste water in over cleaning, avoid focusing on specific places (and instead work “statistically”), in some cases, drying of the cookware by blowing hot air in the general direction of the cookware is also inefficient. The disclosed subject matter addresses these inefficiencies.

One technical solution is to utilize computer vision techniques to identify the cookware and the dirt. Additionally, or alternatively, the specific dish that was prepared therewith, may be determined. In some cases, in case the cookware was used by an automated cooking machine, the dish information and the ingredients used, may be available therefrom. Analysis may be performed, taking into account, the geometric shape of the cookware, the specific stains, the relevant dish, or the like. The analysis creates a cleaning plan that identifies a starting point for the cleaning operation and the cleaning methodology, including the type of cleaning (e.g., steam-based, jet-stream, scrub, or the like). In some exemplary embodiments, an optimal angle for hitting the cookware may be determined and the plan. may take into account such angle. Parameters of the cleaning may be determined, such as water pressure, steam pressure, steam intensity, cleaning time, or the like. Additionally, or alternatively, a drying plan may be determined. The plan may then be executed for cleaning the cookware and drying thereof.

One technical effect of utilizing the disclosed subject matter is to provide for a personalized cleaning operation depending on the cookware to be cleaned. Personalization enables improved efficiency, avoiding over-cleaning “light” dirt, improving effectiveness of each cleaning operation, reducing required energy to perform the cleaning operation and the drying operation, or the like.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

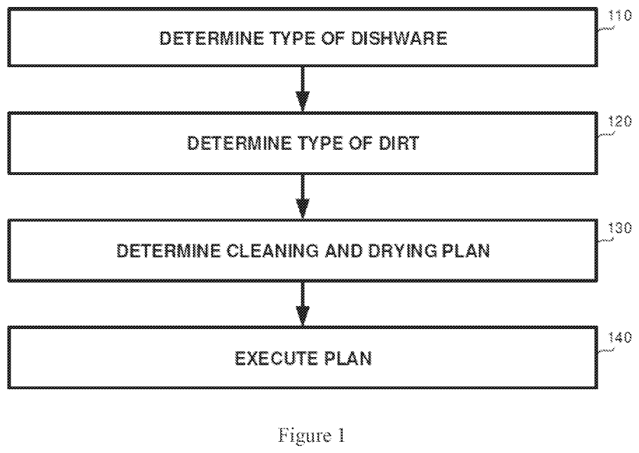

Referring now to FIG. 1 showing a flowchart of a method, in accordance with some exemplary embodiments of the disclosed subject matter.

On Step 210, a type of cookware is identified. In some exemplary embodiments, the type of cookware, such as a pot, a pan, or the like, may be determined. Additionally, or alternatively, the material of the cookware, such as aluminum, day or the like, may be determined. it is noted that different materials may be cleaned at different pressure levels, and using different cleaning methodologies. Additionally, or alternatively, the geometric shape of the cookware, or other geometric properties thereof, may be determined. For example, diameter of the pot may be determined, the depth of the pot may be determined, or the like.

In some exemplary embodiments, sensors, such as a light-sensitive camera, a range sensor, a radar, an ultra-sonic camera, or the like, may be utilized to perform image acquisition. The image may then be processed to identify the type of cookware and properties thereof. In some exemplary embodiments, using image processing diameter of a pot, a depth of a pot, or the like, may be determined. Image processing can also identify the materials of the cookware. In some cases, a machine learning method (e.g., ANN, SVM, or the like) can be trained using a large training dataset to provide high quality predictions for the material.

In some cases, the cookware may be embedded with a marker providing the desired information, such as an RFID, a barcode, or the like. In some exemplary embodiments, a database where each cookware's ID is mapped to its relevant parameters may be utilized. In some cases, the ID may be a product-specific ID, so different pots of the same kind, have different IDs and usage of each cookware can be tracked. Additionally, or alternatively, each product type has an ID.

On Step 120, type of residual dirt on the cookware may be determined. In some exemplary embodiments, the type and composition of dirt may be of importance. Cleaning a pan which was used to prepare an omelet may be substantially different than cleaning the same pan when it is used to caramelize almonds.

In some exemplary embodiments, computer vision may be utilized to identify residue on the cookware to identify which dish was prepared and which type of dirt remains on the cookware that is to be removed by the cleaning operation. Additionally, or alternatively, if the cookware was used by an automated cooking machine, the dish that was prepared using the cookware may be obtained from the automated cooking machine.

The automated cooking machine may provide the list of ingredients that were used, quantity levels of each ingredient, cooking technique that was employed, or consideration of data on cooking temperature, regime and duration, in defining the optimal cleaning and drying cycle.

In some exemplary embodiments, using labeled dataset comprising the image obtained by sensors, and labels thereof provided by an automated cooking machine, a supervised learning technique may be employed to train a classifier to automatically determine the dish that was prepared based on the residual dirt appearing afterwards.

Such classifier may be utilized in case the dish was not prepared by an automated cooking machine. In some exemplary embodiments, such classifier may be utilized by a dishwasher employing the disclosed subject matter, and installed at a private household.

On Step 130, the cleaning and drying plan may be determined. In some exemplary embodiments, analysis may be performed to determine the cleaning and drying plan. in some exemplary embodiments, the plan may be determined based on the geometric shape of the cookware, the material of the cookware, the dish that was cooked thereby, the type of dirt to be cleaned, the location thereof and different amounts in different locations, or the like. The cleaning plan may comprise a starting point at which the cleaning is performed. Additionally, or alternatively, the cleaning plan may comprise cleaning properties for each section of the cookware. The cleaning properties may comprise, for example, a cleaning angle, pressure, intensity, duration, speed, or the like. in some cases, there may be different properties at different locations in the cookware. In some exemplary embodiments, the cleaning angle may be an angle at which a steam is directed at the cookware to remove dirt. There may be optimal angles and sub-optimal angles. In some exemplary embodiments, the plan may maximize utilization of optimal angles. In some exemplary embodiments, sharper angles may provide for a more efficient cleaning and removal of residual dirt. Cleaning of a surface may be planned so as to direct the steam to hit the surface at a sharpest angle. The cleaning is planed while taking into account the geometric limitations imposed by the shape of the cookware, such as its depth and diameter. In some exemplary embodiments, the plan may indicate for different regions different cleaning duration. For dirtier portions, a longer cleaning duration may be employed. In this connection. derivation from the accrued data received from the cooking process, the material and geometry of the cookware, can determine whether a detergent is to be used or not, the amount of detergent and it's compositions

In some exemplary embodiments, a drying plan may be determined. The drying plan may indicate a drying duration and direction to blow the hot air.

In some exemplary embodiments, the plan may indicate how the cookware is to be positioned. In some cases, the cookware may be moved while being cleaned or drying to provide the desired cleaning or drying path along the cookware.

On Step 140, the plan is being executed.

In some exemplary embodiments, the cleaning plan may be executed by controlling the intensity of the steam, the pressure of the steam, the hit angle of the steam at the cookware, and the timing of hitting the cookware. in some exemplary embodiments, the executed cleaning plan may provide improved cleaning in comparison to prior-art dishwashers, in terms of cleaning time, cleaning quality, water usage, energy consumption, or the like. Additionally, or alternatively, the drying plan may be executed by controlling the intensity of the air stream, the angle of the air stream, and the surface at which the air stream is directed. in some exemplary embodiments, the executed drying plan may provide improved drying in comparison to prior-art dishwashers, in terms of drying time, energy consumption, quality of drying, or the like. The drying plan may take into account the shape of the cookware, ensuring air flows to all wet regions of the cookware, overcoming obstacles such as existing in deep pots.

In some exemplary embodiments, the drying plan may correspond to the cleaning plan. As an example, if the cleaning plan started at a center of the pan, and moved outwards there from, the drying plan may also begin at the center and move outwards in a similar manner.

It is noted that the disclosed subject matter is applicable to cookware, dishware, cutlery, or the like, in some cases, the subject item to be cleaned may have been used to present the dish to a diner, to consume the dish by the diner, to prepare the dish, or the like.

The cleaning apparatus and system of cleaning can be summarized in the following steps:

Step 1 Determine Type Dishware

Since different materials are cleaned at different pressure levels using different cleaning methodologies, the cleaning apparatus of the present invention at the first instance determines the following:

Type of cookware the type of cookware if it is a pot, a pan, or any other vessel;

The material of the cookware such as aluminum, clay, steel glass etc.;

the geometric shape of the cookware, the diameter and depth of cookware;

The above features are identified and analyzed by utilizing computer vision techniques configured with the system of the cleaning apparatus. The system utilizes sensors, such as a light-sensitive camera, a range sensor, a radar, an ultra-sonic camera, for image acquisition of the cookware.

The apparatus identifies each cookware by a marker such as an RFID, a barcode, embedded with each cookware which provides the above desired information required for ascertaining the type of cleaning required for each cookware.

Step 2 Determine the Type of Dirt

After the identification of the type of cookware, the next stage is to determine the type of residual dirt on the cookware which is undertaken by utilizing computer vision to identify residue on the cookware to identify which dish was prepared and which type of dirt remains on the cookware that is to be removed by a specific cleaning operation.

Step 3 Determine Cleaning and Drying Plan

In the next step the apparatus performs analysis for creating a cleaning plan which may be performed, taking into account, the geometric shape of the cookware, the specific stains, and the relevant dish. The analysis creates a cleaning plan that identifies a starting point for the cleaning operation and the cleaning methodology, including the type of cleaning (e.g., steam-based, jet-stream, scrub, or the like). Cleaning of a surface of the cookware is planned taking into account an optimal angle so as to direct the steam to hit the surface at a sharpest angle for optimal cleaning. Also taken into account during planning of the cleaning process are the cleaning properties like the cleaning angle, pressure, intensity, duration, speed, and other different properties at different locations in the cookware.

Other parameters of the cleaning which are taken into account are water pressure, steam pressure, steam intensity and the cleaning time. The cleaning is also planned while taking into account the geometric limitations imposed by the shape of the cookware, such as its depth and diameter.

Step 4 Execute Plan

Once the analysis of the cookware and the dirt are complete and a cleaning plan is finalized the 1st step is execution of the plan by the cleaning apparatus.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). in some embodiments, electronic circuitry including, for example, programmable logic circuitry, field programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. it will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated by persons skilled in the art that the present invention is not limited by what has been particularly shown and described hereinabove. Rather the scope of the invention also includes variations and modifications that would occur to persons skilled in the art upon reading the foregoing description and which are not in the prior art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method of cleaning one or more cookware using an automated cleaning apparatus, the method comprising the steps of:
determining the type, shape and material of the of dishware;
wherein,
image acquisition of the cookware is accomplished by utilizing computer vision techniques configured with the system of the cleaning apparatus for identifying and analyzing these features;
wherein,
the computer vision techniques utilizes sensors, including a light-sensitive camera, a range sensor, a radar, an ultra-sonic camera, for image acquisition of the cookware;
determining the type of residual dirt on the cookware by utilizing computer vision and identifying the type of dish prepared on the cookware and finalizing the specific cleaning operation;
analyzing and creating a cleaning plan and identifying a starting point for the cleaning operation and the cleaning methodology;
wherein,
the analysis takes into account the information geometric shape of the cookware, the specific stains, and the relevant dish;
execution of the plan by the cleaning apparatus.

2. A method of cleaning one or more cookware using an automated cleaning apparatus of claim 1, wherein the type of cookware includes a pot, a pan, or any other vessel.

3. A method of cleaning one or more cookware using an automated cleaning apparatus of claim 1, wherein the material of the cookware includes aluminium, clay, steel, and glass.

4. A method of cleaning one or more cookware using an automated cleaning apparatus of claim 1, wherein the shape of the cookware includes the geometric shape, the depth and the diameter of the cookware.

5. A method of cleaning one or more cookware using an automated cleaning apparatus of claim 1, wherein the type of cookware is identified by an electronic tag including an RFID, a barcode, embedded with each cookware.

6. A method of cleaning one or more cookware using an automated cleaning apparatus of claim 1, wherein the creating a plan for type of cleaning includes at least one of the operations like scrubbing, steaming and jet-streaming the dishware.

7. A method of cleaning one or more cookware using an automated cleaning apparatus of claim 1, wherein the creating a plan for type of cleaning also includes considering the cleaning properties including the cleaning angle, pressure, intensity, duration, speed, and other different properties at different locations in the cookware.

8. A method of cleaning one or more cookware using an automated cleaning apparatus of claim 1, wherein the creating a plan for type of cleaning also includes considering the cleaning parameters like water pressure, steam pressure, steam intensity and the cleaning time.

9. A method of cleaning one or more cookware using an automated cleaning apparatus of claim 1, wherein the creating a plan for cleaning of a surface of the cookware also includes considering an optimal angle so as to direct the steam to hit the surface at a sharpest angle for optimal cleaning.

10. An automated cleaning apparatus and system, for cleaning one or more cookware, the apparatus comprising
a processor;
a control unit;
a storage device for storing the database of the cookware;
an array of sensors;
a plurality of cameras;
an electronic tag reader/writer configured with each of the cookware, wherein each electronic tag information is stored in the database of the cookware of the system;
wherein
a module for reading the information of the electronic tag;
a module for determining the shape and material of the cookware;
a module for acquiring and processing digital images;
wherein,
the processor receives a first set of information recorded from the sensors, the digital images acquired by the cameras, electronic tag information of each of the cookware received and which decomposes the set of information to generate a set of machine readable command sequences which is sent to the control unit for controlling the planning, and execution of cleaning of the cookware;
wherein,
the camera is configured to capture images of the cookware providing information regarding the geometric shape of the cookware, the material of the cookware and the type of residual dirt present in the cookware;
wherein,
the sensors are configured to retrieve information relating to the various angles, the material of the cookware, the diameter and depth of the cookware and the residual dirt present in the cookware.

11. An automated cleaning apparatus and system of claim 10, wherein the sensors, includes a light-sensitive camera, a range sensor, a radar, an ultra-sonic camera, for image acquisition of the cookware.

12. An automated cleaning apparatus and system of claim 10, wherein the electronic tag includes an RFID and barcode.

13. An automated cleaning apparatus and system of claim 10, wherein the cleaning apparatus determines the cleaning properties like the cl caning angle, the pressure, intensity, duration and speed of cleaning to be undertaken.

14. An automated cleaning apparatus and system of claim 10, wherein the cleaning apparatus determines the cleaning angle at which the steam will be directed at the cookware to remove dirt from the information received by the images through computer vision techniques.

15. An automated cleaning apparatus and system of claim 10, wherein the computer vision techniques involves receiving image related information from the light-sensitive camera, the range sensor. the radar and an ultra-sonic camera.

16. An automated cleaning apparatus and system of claim 10, wherein the parameters of cleaning like water pressure, steam pressure, steam intensity and the cleaning time is determined by the information received by the images through computer vision techniques.

17. An automated cleaning apparatus and system of claim 10, wherein the parameters of cleaning like water pressure, steam pressure, steam intensity and the cleaning time is determined by the information retrieved by the electronic tag module.
